(19) United States
(12) Patent Application Publication
(10) Pub. No.: US 2026/0066640 A1
(43) Pub. Date: Mar. 5, 2026

(54) ELECTRICAL POWER CONTROL DEVICES AND RELATED METHODS

(71) Applicant: ABB SCHWEIZ AG, Baden (CH)

(72) Inventors: Abhinav Patni, Raleigh, NC (US); Govind Chavan, Garner, NC (US); Sheng Zhong, Hillsborough, NC (US)

(21) Appl. No.: 18/822,962

(22) Filed: Sep. 3, 2024

(51) Int. Cl. H02H 3/08; H02H 1/00

(52) U.S. Cl. CPC H02H 3/08; H02H 1/0007

(57) ABSTRACT

Electrical power control devices may include a power input for transmitting electrical power from a meter socket, a main power connection for transmitting electrical power from the power input to a disconnect panel, and an auxiliary power connection for transmitting electrical power from the power input to an auxiliary device. A main current sensor may be configured to sense a first electrical current passing through the main power connection to the disconnect panel. An auxiliary current sensor may be configured to sense a second electrical current passing through the auxiliary power connection to the auxiliary device. A relay may be coupled to the auxiliary power connection and configured to open to stop flow of at least some of the second electrical current when a total current reaches a predetermined safety threshold. Various other related devices, systems, and methods are also disclosed.

### BACKGROUND

The increasing popularity of electric vehicles (EVs) or other auxiliary electrical devices has led to a rise in energy use in homes. This higher power usage, including from homes with EV chargers, can benefit from electrical power data monitoring. Such monitoring systems may be helpful in comprehending energy use patterns and improving overall consumption. The data obtained can offer homeowners useful details about their energy use, allowing them to better control power and balance between everyday electricity needs and auxiliary demands (e.g., EV charging demands). Higher energy bills can often result from increased electrical loads, making power data monitoring a helpful consideration for homeowners who have auxiliary electrical needs. These monitoring systems can also support utility companies in handling grid load more efficiently, helping avoid power outages or fluctuations that could disrupt service.

### BRIEF SUMMARY

In some aspects, the techniques described herein relate to an electrical power control device, including: a power input for transmitting electrical power from a meter socket; a main power connection for transmitting electrical power from the power input to a disconnect panel; an auxiliary power connection for transmitting electrical power from the power input to an auxiliary device; a main current sensor configured to sense a first electrical current passing through the main power connection to the disconnect panel; an auxiliary current sensor configured to sense a second electrical current passing through the auxiliary power connection to the auxiliary device; and a relay coupled to the auxiliary power connection, wherein the relay is configured to open to stop flow of at least some of the second electrical current through the auxiliary power connection when a combination of the first electrical current and the second electrical current reaches a predetermined safety threshold.

In some aspects, the predetermined safety threshold may be between 50 percent and 95 percent of a maximum ampacity rating of the meter socket.

In some aspects, the predetermined safety threshold may be about 80 percent of a maximum ampacity rating of the meter socket.

In some aspects, the maximum ampacity rating of the meter socket may be in a range of 20 amps to 400 amps.

In some aspects, the relay may be further configured to close to allow the flow of the second electrical current through the auxiliary power connection when the combination of the first electrical current and the second electrical current reaches a predetermined reconnection threshold.

In some aspects, the predetermined reconnection threshold may be lower than the predetermined safety threshold.

In some aspects, the predetermined reconnection threshold may be between 40 percent and 90 percent of a maximum ampacity rating of the meter socket.

In some aspects, the auxiliary power connection may include one or more hot lines; and the relay may be coupled to a hot line of the one or more hot lines of the auxiliary power connection to open the hot line when the combination of the first electrical current and the second electrical current reaches the predetermined safety threshold.

In some aspects, the device may further include one or more microcontrollers connected to the main current sensor, the auxiliary current sensor, and the relay, the one or more microcontrollers being configured to selectively cause the relay to open and close based on data from the main current sensor and the auxiliary current sensor.

In some aspects, the device may further include: an additional auxiliary power connection for transmitting electrical power from the power input to an additional auxiliary device; an additional auxiliary current sensor configured to sense a third electrical current passing through the additional auxiliary power connection to the additional auxiliary device; and an additional relay coupled to the additional auxiliary power connection, wherein the additional relay is configured to open to stop the flow of at least some of the third electrical current through the additional auxiliary power connection when a combination of the first electrical current, the second electrical current, and the third electrical current reaches the predetermined safety threshold.

In some aspects, the device may further include one or more microcontrollers connected to the main current sensor, the auxiliary current sensor, the additional current sensor, the relay, and the additional relay, the one or more microcontrollers being configured to selectively cause one or more of the relay or the additional relay to open and close based on data from the main current sensor, the auxiliary current sensor, and the additional current sensor.

In some aspects, the device may further include a housing containing the main current sensor, the auxiliary current sensor, and the relay.

In some aspects, the meter socket may be an expanded meter socket including the housing.

In some aspects, the housing may be mounted external to the meter socket.

In some aspects, the techniques described herein relate to an electrical power control device, including: a power input for transmitting electrical power from a meter socket; a main power connection for transmitting electrical power from the power input to a disconnect panel; one or more auxiliary power connections for respectively transmitting electrical power from the power input to one or more auxiliary devices; a main current sensor configured to sense a first electrical current passing through the main power connection to the disconnect panel; one or more auxiliary current sensors configured to sense one or more second electrical currents respectively passing through the one or more auxiliary power connections to the one or more auxiliary devices; and one or more relays respectively coupled to the one or more auxiliary power connections, wherein the one or more relays are configured to selectively open to stop flow of at least one of the one or more second electrical currents through the one or more auxiliary power connections when a combination of the first electrical current and the one or more second electrical currents reaches a predetermined safety threshold.

In some aspects, the device may further include one or more microcontrollers connected to the main current sensor, the one or more auxiliary current sensors, and the one or more relays, wherein the one or more microcontrollers is configured to selectively cause the one or more relays to open and close based on data from the main current sensor and the one or more auxiliary current sensors.

In some aspects, the main power connection may include a first hot line and a second hot line; the main current sensor may include a first main current sensor on the first hot line and a second main current sensor on the second hot line; and a highest value from the first main current sensor or the second main current sensor may be used as the first electrical current for determining the combination of the first electrical current and the one or more second electrical currents.

In some aspects, the techniques described herein relate to a method of forming an electrical power control device, the method including: coupling a main current sensor to a main power connection for transmitting electrical power from a meter socket to a disconnect panel to sense a first electrical current passing through the main power connection to the disconnect panel; coupling an auxiliary current sensor to an auxiliary power connection for transmitting electrical power from the meter socket to an auxiliary device to sense a second electrical current passing through the auxiliary power connection to the auxiliary device; and coupling a relay to the auxiliary power connection to stop flow of at least some of the second electrical current through the auxiliary power connection when a combination of the first electrical current and the second electrical current reaches a predetermined safety threshold.

In some aspects, the method may further include: operably connecting one or more microcontrollers to the main current sensor, the auxiliary current sensor, and the relay, the one or more microcontrollers being configured to cause the relay to open or to close based on the combination of the first electrical current and the second electrical current.

In some aspects, coupling the main current sensor to the main power connection may include coupling a first main current sensor to a first hot line of the main power connection and a second main current sensor to a second hot line of the main power connection.

### BRIEF DESCRIPTION OF THE DRAWINGS

FIG. 1 is a schematic diagram of a power supply system that includes an electrical power control device, according to at least one embodiment of the present disclosure.

FIG. 2 is a schematic diagram of a power supply system that includes an electrical power control device, according to at least one additional embodiment of the present disclosure.

FIG. 3 is a schematic diagram of a power supply system that includes an electrical power control device, according to at least one further embodiment of the present disclosure.

FIG. 4 is a schematic diagram of a power supply system that includes an electrical power control device, according to at least one additional embodiment of the present disclosure.

FIG. 5 is a flow diagram illustrating a method of operating an electrical power control device, according to at least one embodiment of the present disclosure.

FIG. 6 is a flow diagram illustrating a method of operating an electrical power control device, according to at least one additional embodiment of the present disclosure.

FIG. 7 is a flow diagram illustrating a method of operating an electrical power control device, according to at least one other embodiment of the present disclosure.

FIG. 8 is a flow diagram illustrating a method of forming an electrical power control device, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides detailed descriptions of electrical power control devices that can manage the electrical power usage of systems that include a main branch (e.g., to a main disconnect panel and associated devices) and an auxiliary branch for one or more auxiliary devices. As will be explained in greater detail below, some embodiments of the present disclosure may include a power input for transmitting electrical power from a meter socket, a main power connection for transmitting electrical power from the power input to a disconnect panel, and an auxiliary power connection for transmitting electrical power from the power input to an auxiliary device. A main current sensor may be configured to sense a first electrical current passing through the main power connection to the disconnect panel and an auxiliary current sensor may be configured to sense a second electrical current passing through the auxiliary power connection to the auxiliary device. A relay may be coupled to the auxiliary power connection. The relay may be configured to open to stop flow of at least some of the second electrical current through the auxiliary power connection when a combination of the first electrical current and the second electrical current reaches a predetermined safety threshold. Such devices may be helpful to reduce a chance of a disconnect (e.g., breaker, fuse, etc.) tripping by automatically shutting off one or more auxiliary devices prior to the disconnect tripping, inhibiting overload in the system as a whole during times of high electricity demand.

Features from any of the embodiments described herein may be used in combination with one another in accordance with the general principles described herein. These and other embodiments, features, and advantages will be more fully understood upon reading the following detailed description in conjunction with the accompanying drawings and claims.

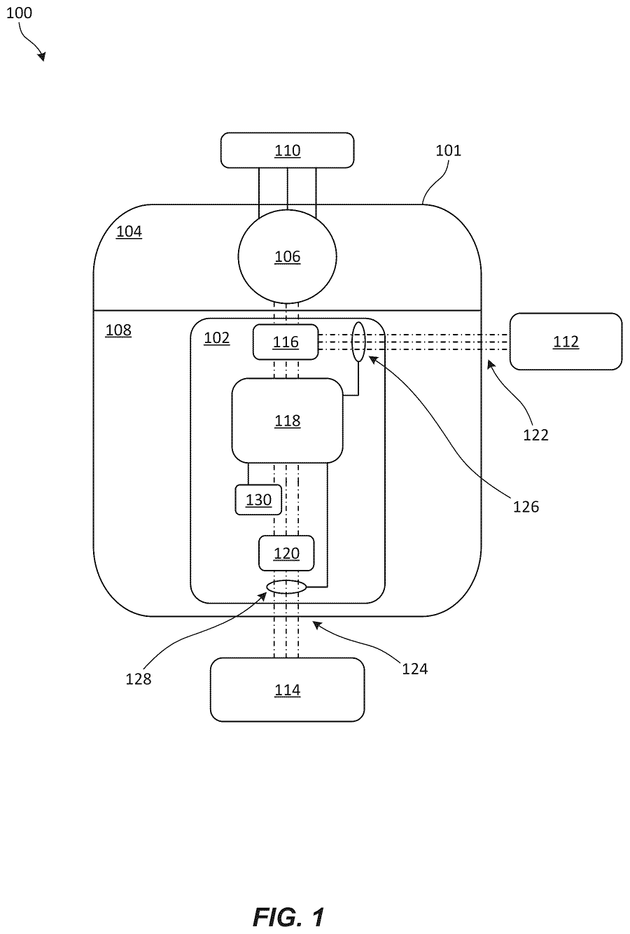

FIG. 1 is a schematic diagram of a power supply system 100 that includes an electrical power control device 102, according to at least one embodiment of the present disclosure. The power supply system 100 may be in the form of an expanded meter socket 101 that includes the electrical power control device 102.

For example, expanded meter socket 101 may be a multi-compartment meter socket 101 including a meter socket section 104 that houses a power meter 106 and a power control section 108 that houses the electrical power control device 102. In some embodiments, the meter socket section 104 may be locked or otherwise access-limited (e.g., for access only by personnel authorized by a power company), such as to inhibit tampering and/or theft of electrical power and for safety. The power control section 108 may be accessible by a user and/or electrician (e.g., without authorization by a power company), such as for installation, maintenance, modification, etc.

The power supply system 100 may be connected at an input side to a utility grid 110 for providing power to the power supply system 100, through the electrical power control device 102, and ultimately to a user's electrical systems, such as to a disconnect panel 112 (e.g., a residential breaker panel, a commercial breaker panel, a fuse box, a fusible switch box, a protective relay panel, etc.) and/or to an auxiliary device 114. In the example shown in FIG. 1, the utility grid 110 may provide a single-phase (e.g., three-wire) alternating current (AC) power supply including at least a hot wire and a neutral wire. In additional examples, the utility grid 110 may be a two-wire AC power supply or a four-wire AC power supply. The AC power supply from the utility grid 110 may be a single-phase (e.g., split-phase) AC power supply or a three-phase AC power supply.

Power from the utility grid 110 may pass through the power meter 106 for measuring total electrical power usage through the disconnect panel 112 and the auxiliary device 114. An output side of the power meter 106 may be operably connected to a power input of the electrical power control device 102, such as via suitable conductors (e.g., cables, wires, traces, etc.).

The electrical power control device 102 may include an input disconnect 116, a data collection and control module 118, and an auxiliary disconnect 120. A main power connection 122 of the electrical power control device 102 may be capable of transmitting electrical power from the electrical power control device 102 to the disconnect panel 112. An auxiliary power connection 124 of the electrical power control device 102 may be capable of transmitting electrical power from the electrical power control device 102 to and/or from the auxiliary device 114.

The input disconnect 116 may be positioned between the power meter 106 and the data collection and control module 118 and between the power meter 106 and the disconnect panel 112. In some embodiments, the input disconnect 116 may be rated with a sufficiently high amperage to supply full power to both the disconnect panel 112 and the auxiliary device 114. In other words, the current rating of the input disconnect 116 may be at least as high as the combination of the disconnect panel 112 rating and of the auxiliary device 114 rating, such as to reduce instances of the input disconnect 116 inadvertently opening and halting service to both the disconnect panel 112 and to the auxiliary device 114.

The auxiliary disconnect 120 may be positioned between the data collection and control module 118 and the auxiliary device 114. The auxiliary disconnect 120 may be configured to interrupt service to or from the auxiliary device 114 for installation or maintenance, in case of a fault (e.g., short-circuit) in the auxiliary device 114, for installation or maintenance of the data collection and control module 118, etc.

As will be explained further below, the data collection and control module 118 may be configured to sense at least one first electrical characteristic of the main power connection 122 and at least one second electrical characteristic of the auxiliary power connection 124. For example, the electrical power control device 102 may include at least one main sensor 126 for sensing the first electrical characteristic of the main power connection 122 and at least one auxiliary sensor 128 for sensing the second electrical characteristic of the auxiliary power connection 124. By way of example and not limitation, each of the at least one main sensor 126 and the at least one auxiliary sensor 128 may be in the form of an inductive sensor, a current shunt sensor, a Hall effect-based sensor, a fluxgate sensor, and/or a Rogowski principle-based sensor (e.g., a Rogowski coil sensor).

The data collection and control module 118 may be in the form of a printed circuit board (PCB) that includes at least an analog-to-digital converter for processing signals from the at least one main sensor 126 and at least one auxiliary sensor 128 and a control module for controlling a flow of electrical current to at least the auxiliary device 114. In some examples, the data collection and control module 118 may also include a communication module for communicating information based on the signals to a user device or other recipient. One or more of these components of the data collection and control module 118 may be implemented via one or more microcontrollers, signal processing components, transistors, transceivers, etc.

In some examples, relational terms, such as “first,” “second,” etc., may be used for clarity and convenience in understanding the disclosure and accompanying drawings and do not connote or depend on any specific preference, orientation, or order, except where the context clearly indicates otherwise.

In some embodiments, the first electrical characteristic and the second electrical characteristic may include current and/or voltage, and/or a characteristic derived from current and/or voltage (e.g., power). The data collection and control module 118 may also be configured to communicate the first and second electrical characteristic, or information based on the first and second electrical characteristic, to a user device or other recipient. For example, the main sensor 126 may be or include a first current sensor for sensing an electrical current in the main power connection 122 and the auxiliary sensor 128 may be or include a second current sensor for sensing an electrical current in the auxiliary power connection 124.

The auxiliary device 114 may be one or more devices that use electrical power. Examples of the auxiliary device 114 include an electric vehicle (EV) charging station, an EV, a pump, an air conditioning unit, a heater, a refrigerator, etc. Other devices that draw electrical power may also be considered auxiliary devices 114. In additional embodiments of the present disclosure, the auxiliary device 114 may generate electricity, and the auxiliary power connection 124 may operate as an input, such as for providing electrical power to the disconnect panel 112. For example, the auxiliary device 114 may be or include a wind turbine, a water turbine, a thermal power generator, a gas generator, a solar panel, etc. In some embodiments, an EV may include sufficient onboard circuitry and components to charge and/or discharge by connecting to a standard (e.g., 110V, 115V, 120V, 208V, 220V, 230V, 240V, etc.) electrical outlet without a separate EV charging station. Examples of such EVs may function as a current load or as a current source. Accordingly, the at least one auxiliary sensor 128 can, in some embodiments, be used to obtain electrical characteristic data regardless of the direction that electrical current flows in the auxiliary power connection 124.

In some embodiments, the electrical power control device 102 may also include a relay 130 operably coupled to at least a portion of the auxiliary power connection 124, such as a hot wire of the auxiliary power connection 124. The relay 130 may be configured to open to stop flow and/or to close to allow flow of at least some electrical current through the auxiliary power connection 124 (e.g., to stop flow of the electrical current through the hot wire of the auxiliary power connection 124). For example, the relay 130 may be configured to open in response to the data collection and control module 118 determining that a total current through the main power connection 122 and through the auxiliary power connection 124 meets or exceeds a predetermined safety threshold (e.g., a threshold between 50 percent and 95 percent of a maximum ampacity rating of the power supply system 100, between 70 percent and 95 percent of the maximum ampacity rating, such as 80 percent of the maximum ampacity rating). The relay 130 may also be configured to close in response to the data collection and control module 118 determining that the total current through the main power connection 122 and through the auxiliary power connection 124 meets or falls below a predetermined reconnection threshold (e.g., equal to or less than the predetermined safety threshold, such as between 40 percent and 90 percent of the maximum ampacity rating of the power supply system 100).

FIG. 1 illustrates a single auxiliary device 114. However, the present disclosure is not so limited. In additional examples, the auxiliary device 114 may represent multiple auxiliary devices 114 connected to the electrical power control device 102. In embodiments in which multiple auxiliary devices 114 are used, a single relay 130 may be used to stop at least some electrical current flow to all auxiliary devices 114 when the predetermined safety threshold is met or exceeded, or a respective relay 130 may be employed for each of the auxiliary devices 114 to selectively stop at least some electrical current flow to one or more of the auxiliary devices 114.

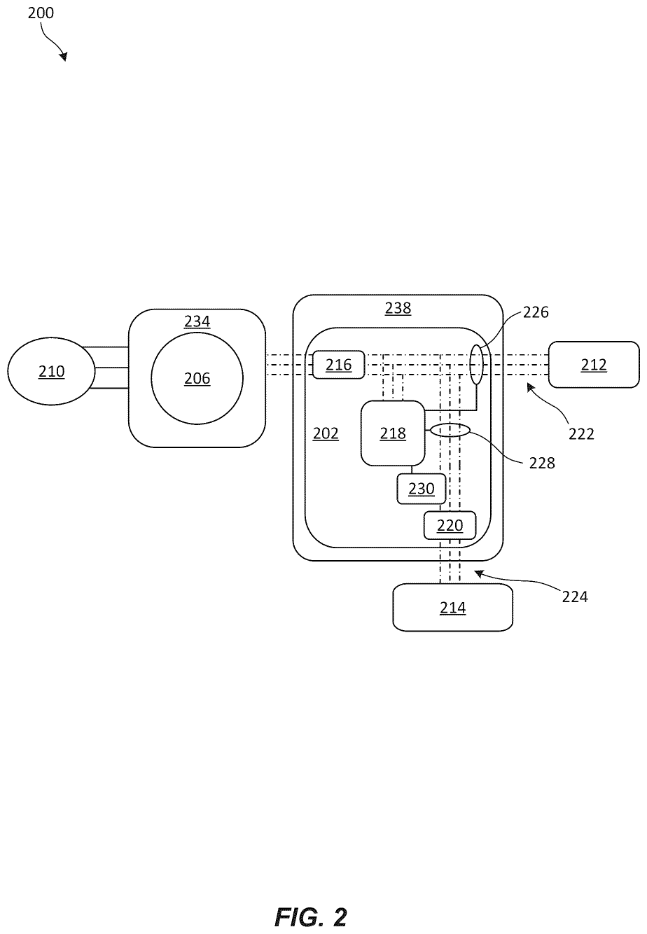

FIG. 2 is a schematic diagram of a power supply system 200 that includes an electrical power control device 202, according to at least one additional embodiment of the present disclosure.

In some respects, the power supply system 200 of FIG. 2 may be similar to the power supply system 100 illustrated in FIG. 1. For example, the power supply system 200 of FIG. 2 may include a power meter 206 that receives electrical power from a utility grid 210, a disconnect panel 212, an auxiliary device 214, and the electrical power control device 202 that is configured to monitor electrical characteristics of a main power connection 222 to the disconnect panel 212 and of an auxiliary power connection 224 to the auxiliary device 214, such as via a main sensor 226 and/or an auxiliary sensor 228. The electrical power control device 202 may include an input disconnect 216, a data collection and control module 218, and an auxiliary disconnect 220. The electrical power control device 202 may also include a relay 230 configured to open to stop flow of at least some electrical current through the auxiliary power connection 224 (e.g., to stop flow of the electrical current through a hot wire of the auxiliary power connection 224) when a predetermined safety threshold is met or exceeded.

Referring to FIG. 2, the power supply system 200 may include a meter socket 234 containing the power meter 206 that is external to (e.g., physically separate from) a housing 238 that contains the electrical power control device 202. In some examples, the housing 238 and electrical power control device 202 therein may be mounted adjacent to (e.g., along a same wall as) the meter socket 234. In additional examples, the housing 238 and electrical power control device 202 may be mounted remotely from the meter socket 234, such as adjacent to the auxiliary device 214 or adjacent to the disconnect panel 212.

Accordingly, referring to FIGS. 1 and 2, electrical power control devices 102, 202 of the present disclosure may be implemented as part of an expanded meter socket 101 or via a housing 238 that is separate from a meter socket 234. The functional components of the electrical power control devices 102, 202 may be the same or similar in either case.

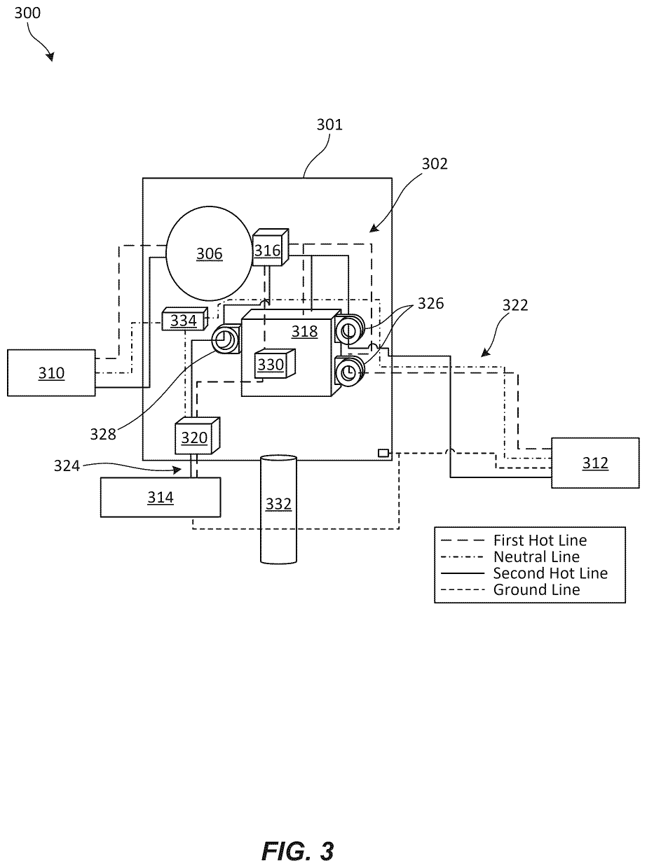

FIG. 3 is a schematic diagram of a power supply system 300 that includes an electrical power control device 302, according to at least one further embodiment of the present disclosure.

In some respects, the power supply system 300 of FIG. 3 may be similar to the power supply system 100 illustrated in FIG. 1. For example, the power supply system 300 of FIG. 3 may include a power meter 306 that receives electrical power from a utility grid 310, a disconnect panel 312, an auxiliary device 314, and the electrical power control device 302 that is configured to monitor electrical characteristics of a main power connection 322 to the disconnect panel 312 and of an auxiliary power connection 324 to the auxiliary device 314, such as via one or more main sensors 326 and/or an auxiliary sensor 328. The power supply system 300 may be implemented in the form of an expanded meter socket 301. The electrical power control device 302 may include an input disconnect 316, a data collection and control module 318, and an auxiliary disconnect 320. The electrical power control device 302 may also include a relay 330 configured to open to stop flow of at least some electrical current through the auxiliary power connection 324 (e.g., to stop flow of the electrical current through at least one hot wire of the auxiliary power connection 324) when a predetermined safety threshold is met or exceeded. The relay 330 may also be configured to close to allow flow of at least some electrical current through the auxiliary power connection 324 when a predetermined reconnection threshold is met.

In FIG. 3, the power supply system 300 is illustrated as a split-phase alternating-current (AC) system. Long dashed connector lines represent a first hot line, dash-dot lines represent a neutral line, solid lines represent a second hot line, and short dashed lines represent a ground line. Components of the power supply system 300 may be operably coupled to one, two, three, or four of these lines, such as depending on their electrical operating characteristics (e.g., designed operating voltage, current, phase, grounding requirements, etc.). The ground line may be electrically coupled to a ground rod 332 or other grounded conductive element, which may in turn be electrically coupled to a housing (e.g., a metal box) of the expanded meter socket 301. The neutral line may be electrically coupled to a neutral lug 334 positioned in the expanded meter socket 301.

In various embodiments of the present disclosure, the power supply system 300 may be a single-phase power system, a split-phase power system, a three-phase power system, a hybrid system, etc.

For example, the data collection and control module 318 may collect and monitor data from the one or more main sensors 326 indicative of a first electrical current passing through the main power connection 322 to the disconnect panel 312, as well as data from the auxiliary sensor 328 indicative of a second electrical current passing through the auxiliary power connection 324 to the auxiliary device 314. Based on this data, the data collection and control module 318 may cause the relay 330 to open or close to respectively stop or allow the flow of electrical current through one or more hot wires of the auxiliary power connection 324. As illustrated in FIG. 3, the relay 330 may, in some embodiments, be operably coupled to one of two hot wires of the auxiliary power connection 324. In additional examples, a single relay or two respective relays may be operably coupled to two hot wires of the auxiliary power connection 324.

For example, if the combination of the first electrical current and the second electrical current reaches a predetermined safety threshold, the data collection and control module 318 may cause the relay 330 to open to stop flow of at least some of the electrical current passing through the auxiliary power connection 324. By way of example and not limitation, the predetermined safety threshold may be between 50 percent and 95 percent of a maximum ampacity rating of the meter socket, such as between 70 percent and 95 percent of the maximum ampacity rating, such as about 80 percent of the maximum ampacity rating. For example, the maximum ampacity rating may be in a range of 100 amps to 400 amps, although other maximum ampacity ratings may be possible in additional situations.

After the relay 330 is opened, reconnection may occur when the combination of the first electrical current and the second electrical current reaches a predetermined reconnection threshold. The predetermined reconnection threshold may be lower than the predetermined safety threshold. For example, the predetermined reconnection threshold may be between about 40 percent and about 90 percent of the maximum ampacity rating of the meter socket, such as about 70 percent of the maximum ampacity rating when the predetermined safety threshold is 80 percent of the maximum ampacity rating. In additional examples, the predetermined reconnection threshold may be 75 percent and the predetermined safety threshold may be 80 percent of the maximum ampacity rating.

In the example shown in FIG. 3, two main sensors 326 are illustrated for measuring an electrical current through the respective first hot line and second hot line. While the electrical current level through the first hot line may be similar to the electrical current through the second hot line, these current levels may not always be identical at any specific time. For determining whether the predetermined safety threshold and/or the predetermined reconnection threshold is met, the data collection and control module 318 may use a highest value for the two main sensors 326 for increased safety.

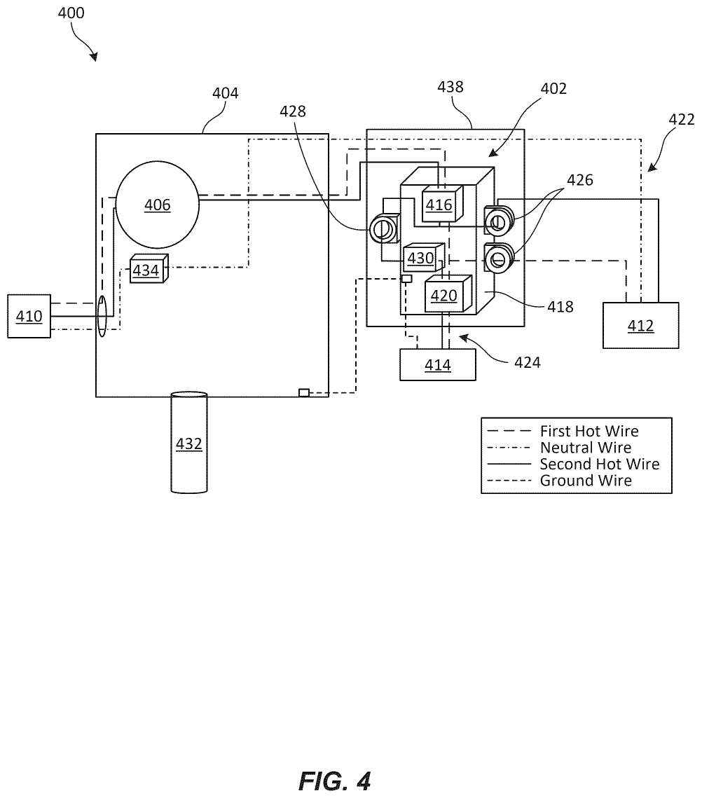

FIG. 4 is a schematic diagram of a power supply system 400 that includes an electrical power control device 402, according to at least one additional embodiment of the present disclosure.

In some respects, the power supply system 400 of FIG. 4 may be similar to the power supply system 200 illustrated in FIG. 2. For example, the power supply system 400 of FIG. 4 may include a power meter 406 that receives electrical power from a utility grid 410, a disconnect panel 412, an auxiliary device 414, and the electrical power control device 402 that is configured to monitor electrical characteristics of a main power connection 422 to the disconnect panel 412 and of an auxiliary power connection 424 to the auxiliary device 414, such as via one or more main sensors 426 and/or an auxiliary sensor 428. The electrical power control device 402 may be contained in a housing 438 that is separate from a meter socket 404 that contains the power meter 406.

The electrical power control device 402 may include an input disconnect 416, a data collection and control module 418, and an auxiliary disconnect 420. The electrical power control device 402 may also include a relay 430 configured to open to stop flow of at least some electrical current through the auxiliary power connection 424 (e.g., to stop flow of the electrical current through at least one hot wire of the auxiliary power connection 424) when a predetermined safety threshold is met or exceeded. The relay 430 may also be configured to close to allow flow of at least some electrical current through the auxiliary power connection 424 when a predetermined reconnection threshold is met.

A ground rod 432 or other grounded conductive element may be electrically coupled to a housing of the meter socket 404 and/or to the housing 438 that contains the electrical power control device 402.

The data collection and control module 418 may collect and monitor data from the one or more main sensors 426 indicative of a first electrical current passing through the main power connection 422 to the disconnect panel 412, as well as data from the auxiliary sensor 428 indicative of a second electrical current passing through the auxiliary power connection 424 to the auxiliary device 414. Based on this data, the data collection and control module 418 may cause the relay 430 to open or close to respectively stop or allow the flow of electrical current through one or more hot wires of the auxiliary power connection 424. For example, the data collection and control module 418 may cause the relay 430 to respectively open and close when the total electrical current passing through the main power connection 422 and auxiliary power connection 424 reaches the predetermined safety threshold and the predetermined reconnection threshold.

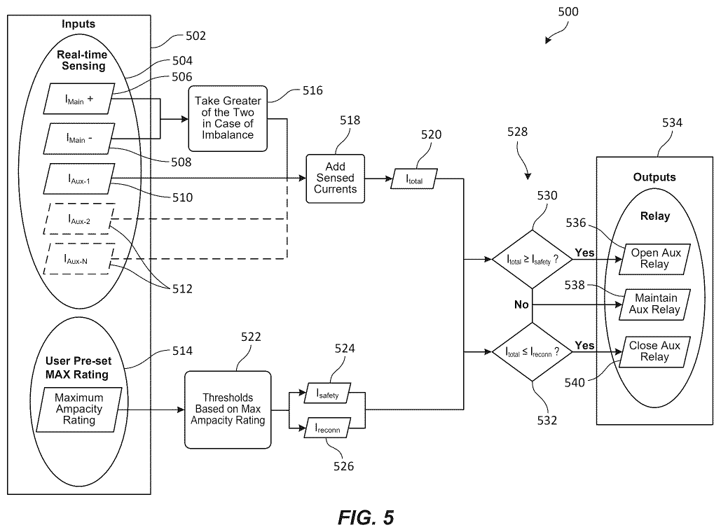

FIG. 5 is a flow diagram illustrating a method 500 of operating an electrical power control device, according to at least one embodiment of the present disclosure. The method 500 may be implemented by a power supply system, such as any of the power supply systems 100, 200, 300, 400 described above.

At operation 502, various inputs may be received by the power supply system. For example, real-time sensing 504 of a first main current 506 (e.g., through a first hot wire of a main power connection), second main current 508 (e.g., through a second hot wire of the main power connection), and auxiliary current 510 (e.g., through a hot wire of an auxiliary power connection) may be performed, such as by respective electrical current sensors. Optionally, if more than one auxiliary device is present, real-time sensing 504 of one or more additional auxiliary currents 512 may also be performed.

A user pre-set maximum rating 514 may also be an input received by the power supply system. The maximum rating 514 may be based on a maximum ampacity rating of a meter socket through which electrical power is provided to a house or commercial establishment. For example, the maximum ampacity rating may be determined based on indications from a manufacturer of the meter socket. For example, the maximum ampacity rating may be in a range of 20 amps to 400 amps, such as 20 amps, 80 amps, 100 amps, 160 amps, 200 amps, 320 amps, or 400 amps. The maximum ampacity rating may be set by a user during installation of the power supply system or at a later time, such as via toggling a physical switch or by entering the maximum ampacity rating via a software interface.

At operation 516, the first main current 506 and the second main current 508 may be compared to determine which is greater in case there is an imbalance between the two. The greater of the two currents may be used for increased safety in the power supply system.

At operation 518, the greater main current 506 or 508 may be added to the auxiliary current 510 (and any additional auxiliary currents 512, if applicable) to obtain a total current 520 passing through the power supply system.

At operation 522, thresholds based on the maximum ampacity rating 514 may be determined. For example, a predetermined safety threshold 524 may be between 50 percent and 95 percent of the maximum ampacity rating 514, such as between 70 percent and 95 percent of the maximum ampacity rating 514, such as about 80 percent of the maximum ampacity rating 514. The percentage of the predetermined safety threshold 524 may be selected by a user or may be pre-set. A predetermined reconnection threshold 526 may be less than the predetermined safety threshold 524, such as between about 40 percent and 90 percent of the maximum ampacity rating 514. The percentage of the predetermined reconnection threshold 526 may be selected by a user or may be pre-set.

At decision point 528, the total current 520 may be compared to the predetermined safety threshold 524 and the predetermined reconnection threshold 526. For example, at query 530, the system may determine whether the total current 520 is greater than or equal to the predetermined safety threshold 524. At query 532, the system may determine whether the total current 520 is less than or equal to the predetermined reconnection threshold 526.

Outputs 534 may depend on answers to query 530 and query 532. The outputs 534 may be opening 536 an auxiliary relay to stop the flow of electrical current to an auxiliary device, closing 540 the auxiliary relay to allow the flow of electrical current to the auxiliary device, or maintaining 538 the present state of the auxiliary relay, whether open or closed. For example, if the answer to query 530 is yes and the total current 520 is greater than or equal to the predetermined safety threshold 524, then the system may cause the opening 536 of the auxiliary relay (or to remain open if already open). If the answer to the query 530 is no, then the system may cause the maintaining 538 of the present state of the auxiliary relay (e.g., if already open, the auxiliary relay may remain open; or if already closed, the auxiliary relay may remain closed). If the answer to query 532 is yes and the total current 520 is less than or equal to the predetermined reconnection threshold 526, then the system may cause the closing 540 of the auxiliary relay (or to remain closed if already closed). If the answer to query 532 is no, then the system may cause the maintaining 538 of the present state of the auxiliary relay (e.g., if already open, the auxiliary relay may remain open; or if already closed, the auxiliary relay may remain closed).

The outputs 534 may be performed automatically in response to the system sensing the electrical currents and comparing those to the predetermined thresholds as outlined above. By automatically opening and closing the auxiliary relay to manage the flow of electrical current to one or more auxiliary devices, the main electrical current flow may not be interrupted even during periods of high electrical demand. In addition, the chance of disconnects (e.g., breakers and/or fuses) tripping may be considerably less, which may also reduce the need for a consumer to manually correct those interruptions.

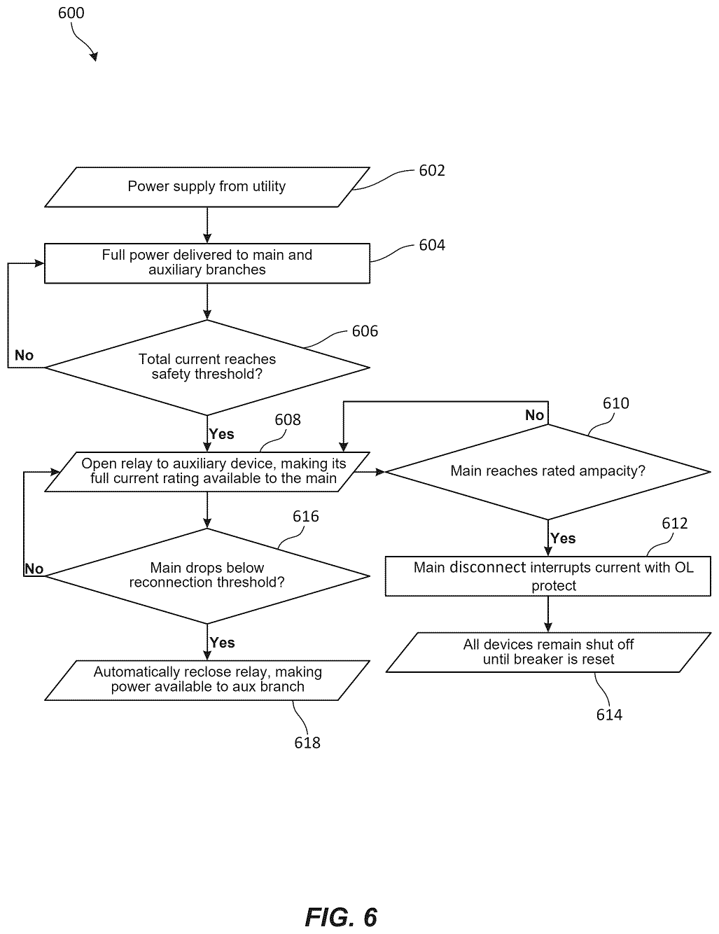

FIG. 6 is a flow diagram illustrating a method 600 of operating an electrical power control device, according to at least one additional embodiment of the present disclosure.

Typically, electrical overload protection occurs as follows. A consumer receives power from a utility grid and uses the power for various electrical devices. If there is a period of high electrical demand and the total current usage exceeds a total ampacity rating, a circuit breaker and/or fuse trips to interrupt the flow of current to one or more of the electrical devices. To regain power, the user must manually reset the breaker or replace the fuse.

The method 600 of FIG. 6 may reduce the chance that a user will need to manually reset a breaker or replace a fuse, even in periods of high demand, by shutting off or turning on the flow of electrical current to an auxiliary device based on thresholds that may be reached prior to a main circuit breaker and/or fuse tripping.

In the method 600 of FIG. 6, at operation 602, electrical power may be received from a utility service provider (e.g., from a utility grid). At operation 604, a full amount of the power received from the utility service provider may be delivered to a main electrical branch (e.g., to a main disconnect panel and ultimately to main electrical devices) and to an auxiliary electrical branch (e.g., to an auxiliary device, such as an EV charging station, an EV, a pump, an air conditioning unit, a heater, a refrigerator, etc.).

At operation 606, the system may determine whether a total current (e.g., the current to both the main and auxiliary branches) reaches a predetermined safety threshold (e.g., 80 percent of a total ampacity of the system). If the predetermined safety threshold is not yet reached, then the full power may continue to be delivered to the main and auxiliary branches as in operation 604. If the predetermined safety threshold is reached, then a relay may be opened at operation 608 to stop the flow of current to the auxiliary device. This current that the disconnected auxiliary device was using may be made available to the main branch without interrupting service to the main branch.

Next, the system operates with the relay to the auxiliary device open by continuing to deliver electricity to the main branch. The system may continuously monitor whether the current flowing to the main branch reaches the total ampacity of the system at operation 610. If not, the system may continue to operate with the relay to the auxiliary device opened. If the current flowing to the main branch does reach the total ampacity of the system, then the main disconnect may be tripped to interrupt current and protect the system against overload (OL) at operation 612. In this case, at operation 614, all devices on the main branch and auxiliary branch may remain shut off until the main disconnect is reset (e.g., manually).

Referring again to a state in which the relay to the auxiliary device is open because of operation 608, the system may continuously monitor the current flow to determine whether the current delivered to the main branch drops below a predetermined reconnection threshold at operation 616. If not, then the system may continue to deliver power to the main branch but not to the auxiliary branch. If the current delivered to the main branch does drop below the predetermined reconnection threshold, then the relay to the auxiliary device may be automatically reclosed at operation 618. With the relay closed, power may be made available to and may be delivered to the auxiliary branch and to the main branch, as identified in operation 604.

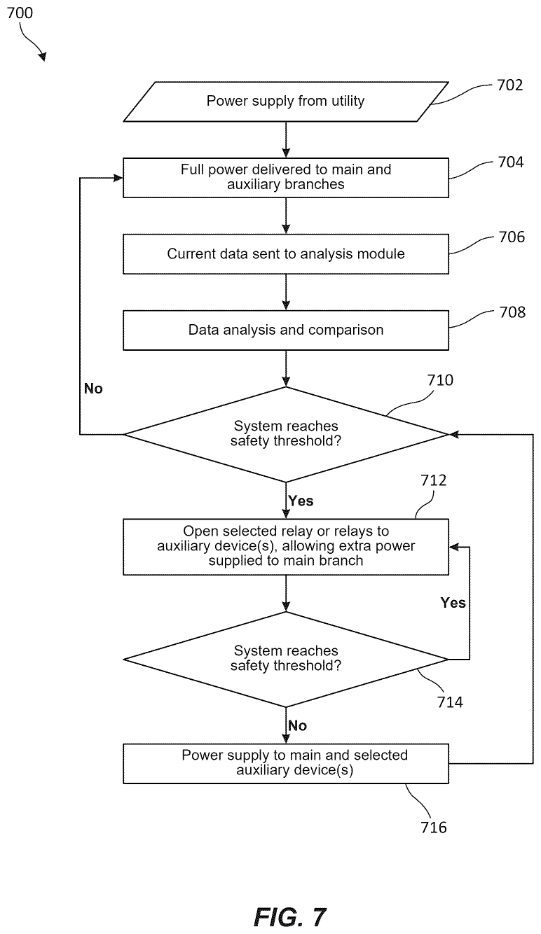

FIG. 7 is a flow diagram illustrating a method 700 of operating an electrical power control device, according to at least one other embodiment of the present disclosure. In some respects, the method 700 of FIG. 7 may be performed in a similar manner to the method 600 of FIG. 6. However, the method 700 of FIG. 7 may be tailored for systems with multiple auxiliary devices and respective relays.

At operation 702, electrical power may be received from a utility service provider. At operation 704, the electrical power may be delivered to a main branch (e.g., a main disconnect panel and ultimately to main electrical devices) and to multiple auxiliary branches (e.g., to more than one auxiliary device). Electrical current sensors may be respectively operably coupled to each auxiliary branch and to the main branch. At operation 706, data representative of the sensed electrical current may be sent to an analysis module (e.g., any of the data collection and control modules 118, 218, 318, 418 described above). At operation 708, the analysis module may analyze the received data and may compare the total current through the main branch and all active auxiliary branches to a predetermined safety threshold.

At operation 710, the system may determine whether the total current in the system reaches the predetermined safety threshold. If not, the system may continue to operate as in operation 704, with the full power delivered to the main and auxiliary branches. If the total current does reach the predetermined safety threshold, then operation 712 may be performed to open one or more selected relays to one or more respective auxiliary devices to reduce the total current and allow extra electrical power to be supplied to the main branch. By way of example, operation 712 may be performed by initially shutting off the auxiliary device that draws the most power, the auxiliary device that draws the least power, or an auxiliary device that is pre-selected to have a lowest priority. In the latter case, a user may pre-select an order of priority of auxiliary devices to inform the system the order in which the auxiliary devices should be shut off when the predetermined safety threshold is met. In some examples, more than one auxiliary device may be simultaneously shut off.

After shutting off one or more auxiliary devices by opening selected relay(s), operation 714 may be performed to again determine whether the total current in the system (e.g., in the main branch and any remaining connected auxiliary branch(es)) reaches the predetermined safety threshold. If so, operation 712 may again be performed to shut off one or more additional auxiliary devices to allow additional power to be supplied to the main branch. If not, the system may continue to operate to supply power to the main branch and/or one or more auxiliary devices that remain connected.

As discussed above, if the total power usage drops to a predetermined reconnection threshold (e.g., at operation 710 or operation 714), then the system may close one or more selected relays to reconnect one or more corresponding auxiliary devices.

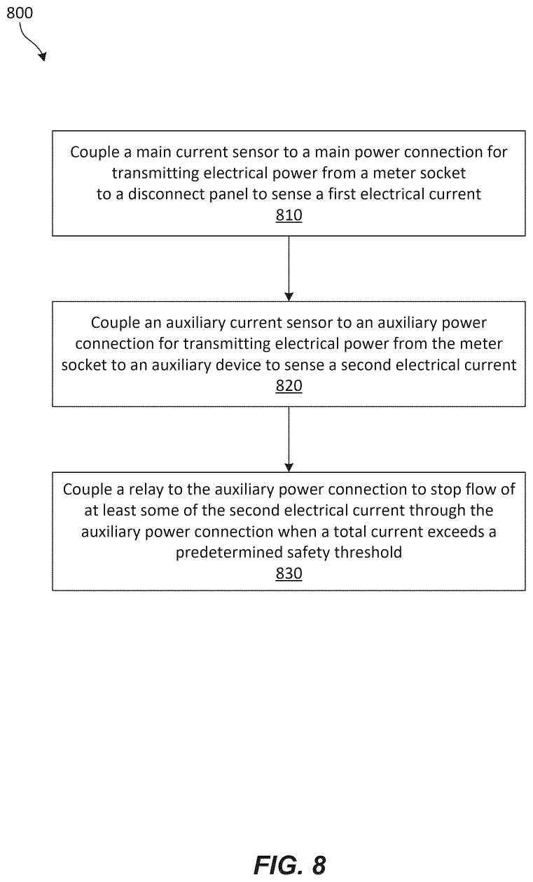

FIG. 8 is a flow diagram illustrating a method 800 of forming an electrical power control device, according to at least one embodiment of the present disclosure.

At operation 810, a main current sensor may be coupled to a main power connection for transmitting electrical power from a meter socket to a disconnect panel. The main current sensor may be configured to sense a first electrical current passing through the main power connection to the disconnect panel.

At operation 820, an auxiliary current sensor may be coupled to an auxiliary power connection for transmitting electrical power from the meter socket to an auxiliary device. The auxiliary current sensor may be configured to sense a second electrical current passing through the auxiliary power connection to the auxiliary device.

At operation 830, a relay may be coupled to the auxiliary power connection to stop flow of at least some of the second electrical current through the auxiliary power connection when a total current (e.g., a combination of the first electrical current and the second electrical current) reaches a predetermined safety threshold.

In some examples, the term “about” in reference to a given parameter, property, or condition, may refer to a degree that one skilled in the art would understand that the given parameter, property, or condition is met with a small degree of variance, such as within acceptable manufacturing tolerances and/or conventional measurement techniques. For example, a parameter that is “about” met may be at least about 90% met, at least about 95% met, at least about 99% met, or fully met.

Accordingly, the present disclosure includes devices, systems, and methods that may be useful for managing electrical power usage in systems that include a main power branch (e.g., to a disconnect panel) and one or more auxiliary power branches (e.g., to one or more auxiliary devices). These concepts may be employed to automatically shut off or reconnect power to one or more auxiliary devices when electrical current thresholds are met to reduce the chance of disconnects tripping during periods of high electricity usage.

The following example embodiments are also included in the present disclosure.

Example 1. An electrical power control device, including: a power input for transmitting electrical power from a meter socket; a main power connection for transmitting electrical power from the power input to a disconnect panel; an auxiliary power connection for transmitting electrical power from the power input to an auxiliary device; a main current sensor configured to sense a first electrical current passing through the main power connection to the disconnect panel; an auxiliary current sensor configured to sense a second electrical current passing through the auxiliary power connection to the auxiliary device; and a relay coupled to the auxiliary power connection, wherein the relay is configured to open to stop flow of at least some of the second electrical current through the auxiliary power connection when a combination of the first electrical current and the second electrical current reaches a predetermined safety threshold.

Example 2. The device of Example 1, wherein the predetermined safety threshold is between 50 percent and 95 percent of a maximum ampacity rating of the meter socket.

Example 3. The device of Example 2, wherein the predetermined safety threshold is about 80 percent of a maximum ampacity rating of the meter socket.

Example 4. The device of Example 2 or Example 3, wherein the maximum ampacity rating of the meter socket is in a range of 20 amps to 400 amps.

Example 5. The device of any one of Examples 1 through 4, wherein the relay is further configured to close to allow the flow of the second electrical current through the auxiliary power connection when the combination of the first electrical current and the second electrical current reaches a predetermined reconnection threshold.

Example 6. The device of Example 5, wherein the predetermined reconnection threshold is lower than the predetermined safety threshold.

Example 7. The device of Example 6, wherein the predetermined reconnection threshold is between 40 percent and 90 percent of a maximum ampacity rating of the meter socket.

Example 8. The device of any one of Examples 1 through 7, wherein: the auxiliary power connection includes one or more hot lines; and the relay is coupled to a hot line of the one or more hot lines of the auxiliary power connection to open the hot line when the combination of the first electrical current and the second electrical current reaches the predetermined safety threshold.

Example 9. The device of any one of Examples 1 through 8, further including one or more microcontrollers connected to the main current sensor, the auxiliary current sensor, and the relay, the one or more microcontrollers being configured to selectively cause the relay to open and close based on data from the main current sensor and the auxiliary current sensor.

Example 10. The device of any one of Examples 1 through 9, further including: an additional auxiliary power connection for transmitting electrical power from the power input to an additional auxiliary device; an additional auxiliary current sensor configured to sense a third electrical current passing through the additional auxiliary power connection to the additional auxiliary device; and an additional relay coupled to the additional auxiliary power connection, wherein the additional relay is configured to open to stop the flow of at least some of the third electrical current through the additional auxiliary power connection.

Example 11. The device of Example 10, further including one or more microcontrollers connected to the main current sensor, the auxiliary current sensor, the additional current sensor, the relay, and the additional relay, the one or more microcontrollers being configured to selectively cause one or more of the relay or the additional relay to open and close based on data from the main current sensor, the auxiliary current sensor, and the additional current sensor.

Example 12. The device of any one of Examples 1 through 11, further including a housing containing the main current sensor, the auxiliary current sensor, and the relay.

Example 13. The device of Example 12, wherein the meter socket is an expanded meter socket including the housing.

Example 14. The device of Example 12, wherein the housing is mounted external to the meter socket.

Example 15. An electrical power control device, including: a power input for transmitting electrical power from a meter socket; a main power connection for transmitting electrical power from the power input to a disconnect panel; one or more auxiliary power connections for respectively transmitting electrical power from the power input to one or more auxiliary devices; a main current sensor configured to sense a first electrical current passing through the main power connection to the disconnect panel; one or more auxiliary current sensors configured to sense one or more second electrical currents respectively passing through the one or more auxiliary power connections to the one or more auxiliary devices; and one or more relays respectively coupled to the one or more auxiliary power connections, wherein the one or more relays are configured to selectively open to stop flow of at least one of the one or more second electrical currents through the one or more auxiliary power connections when a combination of the first electrical current and the one or more second electrical currents reaches a predetermined safety threshold.

Example 16. The device of Example 15, further including one or more microcontrollers connected to the main current sensor, the one or more auxiliary current sensors, and the one or more relays, wherein the one or more microcontrollers is configured to selectively cause the one or more relays to open and close based on data from the main current sensor and the one or more auxiliary current sensors.

Example 17. The device of Example 15 or Example 16, wherein: the main power connection includes a first hot line and a second hot line; the main current sensor includes a first main current sensor on the first hot line and a second main current sensor on the second hot line; and a highest value from the first main current sensor or the second main current sensor is used as the first electrical current for determining the combination of the first electrical current and the one or more second electrical currents.

Example 18. A method of forming an electrical power control device, the method including: coupling a main current sensor to a main power connection for transmitting electrical power from a meter socket to a disconnect panel to sense a first electrical current passing through the main power connection to the disconnect panel; coupling an auxiliary current sensor to an auxiliary power connection for transmitting electrical power from the meter socket to an auxiliary device to sense a second electrical current passing through the auxiliary power connection to the auxiliary device; and coupling a relay to the auxiliary power connection to stop flow of at least some of the second electrical current through the auxiliary power connection when a combination of the first electrical current and the second electrical current reaches a predetermined safety threshold.

Example 19. The method of Example 18, further including: operably connecting one or more microcontrollers to the main current sensor, the auxiliary current sensor, and the relay, the one or more microcontrollers being configured to cause the relay to open or to close based on the combination of the first electrical current and the second electrical current.

Example 20. The method of Example 18 or Example 19, wherein coupling the main current sensor to the main power connection includes coupling a first main current sensor to a first hot line of the main power connection and a second main current sensor to a second hot line of the main power connection.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An electrical power control device, comprising:
a power input for transmitting electrical power from a meter socket;
a main power connection for transmitting electrical power from the power input to a disconnect panel;
an auxiliary power connection for transmitting electrical power from the power input to an auxiliary device;
a main current sensor configured to sense a first electrical current passing through the main power connection to the disconnect panel;
an auxiliary current sensor configured to sense a second electrical current passing through the auxiliary power connection to the auxiliary device; and
a relay coupled to the auxiliary power connection, wherein the relay is configured to open to stop flow of at least some of the second electrical current through the auxiliary power connection when a combination of the first electrical current and the second electrical current reaches a predetermined safety threshold.

2. The device of claim 1, wherein the predetermined safety threshold is between 50 percent and 95 percent of a maximum ampacity rating of the meter socket.

3. The device of claim 2, wherein the predetermined safety threshold is about 80 percent of a maximum ampacity rating of the meter socket.

4. The device of claim 2, wherein the maximum ampacity rating of the meter socket is in a range of 20 amps to 400 amps.

5. The device of claim 1, wherein the relay is further configured to close to allow the flow of the second electrical current through the auxiliary power connection when the combination of the first electrical current and the second electrical current reaches a predetermined reconnection threshold.

6. The device of claim 5, wherein the predetermined reconnection threshold is lower than the predetermined safety threshold.

7. The device of claim 6, wherein the predetermined reconnection threshold is between 40 percent and 90 percent of a maximum ampacity rating of the meter socket.

8. The device of claim 1, wherein:
the auxiliary power connection comprises one or more hot lines; and
the relay is coupled to a hot line of the one or more hot lines of the auxiliary power connection to open the hot line when the combination of the first electrical current and the second electrical current reaches the predetermined safety threshold.

9. The device of claim 1, further comprising one or more microcontrollers connected to the main current sensor, the auxiliary current sensor, and the relay, the one or more microcontrollers being configured to selectively cause the relay to open and close based on data from the main current sensor and the auxiliary current sensor.

10. The device of claim 1, further comprising:
an additional auxiliary power connection for transmitting electrical power from the power input to an additional auxiliary device;
an additional auxiliary current sensor configured to sense a third electrical current passing through the additional auxiliary power connection to the additional auxiliary device; and
an additional relay coupled to the additional auxiliary power connection, wherein the additional relay is configured to open to stop the flow of at least some of the third electrical current through the additional auxiliary power connection.

11. The device of claim 10, further comprising one or more microcontrollers connected to the main current sensor, the auxiliary current sensor, the additional current sensor, the relay, and the additional relay, the one or more microcontrollers being configured to selectively cause one or more of the relay or the additional relay to open and close based on data from the main current sensor, the auxiliary current sensor, and the additional current sensor.

12. The device of claim 1, further comprising a housing containing the main current sensor, the auxiliary current sensor, and the relay.

13. The device of claim 12, wherein the meter socket is an expanded meter socket comprising the housing.

14. The device of claim 12, wherein the housing is mounted external to the meter socket.

15. An electrical power control device, comprising:
a power input for transmitting electrical power from a meter socket;
a main power connection for transmitting electrical power from the power input to a disconnect panel;
one or more auxiliary power connections for respectively transmitting electrical power from the power input to one or more auxiliary devices;
a main current sensor configured to sense a first electrical current passing through the main power connection to the disconnect panel;
one or more auxiliary current sensors configured to sense one or more second electrical currents respectively passing through the one or more auxiliary power connections to the one or more auxiliary devices; and
one or more relays respectively coupled to the one or more auxiliary power connections, wherein the one or more relays are configured to selectively open to stop flow of at least one of the one or more second electrical currents through the one or more auxiliary power connections when a combination of the first electrical current and the one or more second electrical currents reaches a predetermined safety threshold.

16. The device of claim 15, further comprising one or more microcontrollers connected to the main current sensor, the one or more auxiliary current sensors, and the one or more relays, wherein the one or more microcontrollers is configured to selectively cause the one or more relays to open and close based on data from the main current sensor and the one or more auxiliary current sensors.

17. The device of claim 15, wherein:
the main power connection comprises a first hot line and a second hot line;
the main current sensor comprises a first main current sensor on the first hot line and a second main current sensor on the second hot line; and
a highest value from the first main current sensor or the second main current sensor is used as the first electrical current for determining the combination of the first electrical current and the one or more second electrical currents.

18. A method of forming an electrical power control device, the method comprising:
coupling a main current sensor to a main power connection for transmitting electrical power from a meter socket to a disconnect panel to sense a first electrical current passing through the main power connection to the disconnect panel;
coupling an auxiliary current sensor to an auxiliary power connection for transmitting electrical power from the meter socket to an auxiliary device to sense a second electrical current passing through the auxiliary power connection to the auxiliary device; and
coupling a relay to the auxiliary power connection to stop flow of at least some of the second electrical current through the auxiliary power connection when a combination of the first electrical current and the second electrical current reaches a predetermined safety threshold.

19. The method of claim 18, further comprising:
operably connecting one or more microcontrollers to the main current sensor, the auxiliary current sensor, and the relay, the one or more microcontrollers being configured to cause the relay to open or to close based on the combination of the first electrical current and the second electrical current.

20. The method of claim 18, wherein coupling the main current sensor to the main power connection comprises coupling a first main current sensor to a first hot line of the main power connection and a second main current sensor to a second hot line of the main power connection.
